(19) United States
(12) Patent Application Publication
(10) Pub. No.: US 2025/0013500 A1
(43) Pub. Date: Jan. 9, 2025

(54) DEEP REINFORCEMENT LEARNING-BASED CLOUD DATA CENTER ADAPTIVE EFFICIENT RESOURCE ALLOCATION METHOD

(71) Applicant: FUZHOU UNIVERSITY, Fuzhou, Fujian (CN)

(72) Inventors: Zheyi Chen, Fujian (CN); Bing Xiong, Fujian (CN); Lixian Chen, Fujian (CN)

(73) Assignee: FUZHOU UNIVERSITY, Fuzhou, Fujian (CN)

(21) Appl. No.: 18/246,048

(22) PCT Filed: Oct. 20, 2022
(86) PCT No.: PCT/CN2022/126468

§ 371 Date: Mar. 21, 2023

(30) Foreign Application Priority Data
Mar. 28, 2022 (CN) 202210309973.8

(51) Int. Cl. G06F 9/50

(52) U.S. Cl. CPC G06F 9/5038; G06F 9/5072; G06F 9/5094

(57) ABSTRACT

The present invention relates to a deep reinforcement learning-based cloud data center adaptive efficient resource allocation method. First, an operation (a scheduling job) is selected according to a score evaluated by critic (an evaluation operation) by using an actor parameterized policy (resource allocation). Then, a resource allocation policy is updated through gradient boosting, and a variance of a policy gradient is reduced by using an advantage function, to improve training efficiency; and wide simulation experiments are performed by using real data from a Google cloud data center. Compared with two advanced DRL-based cloud resource allocation methods and five classic cloud resource allocation methods, the method provided in the present invention has higher quality of service (QoS) in terms of a delay and a job dropout rate and has higher energy efficiency.

### FIELD OF TECHNOLOGY

The present invention relates to a deep reinforcement learning-based cloud data center adaptive efficient resource allocation method.

### BACKGROUND

Cloud computing has rapidly developed as one of the most prevailing computing paradigms. In the cloud computing, resource allocation refers to a process of allocating computing, storage, and networking resources to meet the demands of both users and cloud service providers. Many problems in cloud resource allocation have emerged with the ever-increasing scale and dynamics of cloud data centers, for example, irrational resource allocation and slow response to changes. These problems not only reduce the quality of service, but also lead to relatively high energy consumption and maintenance costs. Therefore, it is urgent to design an adaptive and efficient solution for resource allocation in the cloud data centers. However, it is a highly challenging task due to the dynamic system states and various user demands in cloud computing, as described below:

The complexity of the cloud data centers: There are a large quantity of different types of servers in the cloud data centers, which provide various computing and storage resources, including CPUs, memories and storage units. Therefore, it is challenging to manage and coordinate heterogeneous resources efficiently in cloud computing.

The diversity of demands from the users: jobs from different users require heterogeneous resources (for example, the CPUs, the memories, and the storage units) and different durations (for example, minutes, hours, and days). The diversity of the user demands increases the difficulty of resource allocation in the cloud data centers.

The excessiveness of energy consumption: A large amount of energy consumption not only causes huge operating overheads, but also leads to large carbon emissions. In Google cloud data center, the average CPU utilization of servers is only about 20%. Such energy waste occurs when irrational resource allocation solutions are used. However, it is difficult to meet diverse user demands while maintaining an efficient and energy-saving cloud data center.

The dynamicity of cloud systems: In the cloud data centers, system states such as resource usage and requests are changing frequently. Under such a dynamic cloud environment, it is expected that effective resource allocation can continuously meet the demands of the user jobs. However, in the dynamic cloud environment, it is difficult to establish an accurate resource allocation model. Therefore, the dynamicity brings a great challenge to the adaptive resource allocation of the cloud data centers.

Many classic solutions for cloud resource allocation are based on rules, heuristics, and control theories. Although these solutions can resolve the problem of cloud resource allocation to a certain extent, these solutions usually use the prior knowledge (for example, state transition, demand change, and energy consumption) of the cloud system to formulate corresponding resource allocation policies. As a result, these solutions may work well in specific application scenarios, but cannot fully adapt to cloud environments with dynamic system states and user demands. For example, job scheduling can be easily performed by using a rule-based policy to meet instant user demands. However, only current job characteristics (for example, resource demands and working hours) are considered to obtain short-term benefits. Consequently, these solutions cannot adaptively meet the dynamic job demands of the users from a long-term perspective, and it may result in an excessive job delay and serious resource waste due to irrational resource allocation. In addition, these solutions may require a plurality of iterations to find a feasible resource allocation solution, which leads to relatively high computational complexity and resource overheads. As a result, these solutions cannot effectively resolve the complex resource allocation problem in the dynamic cloud environment.

Reinforcement learning (Reinforcement Learning, RL) is a resource allocation method with high self-adaptability and low complexity. However, a conventional RL-based method has the problem of high-dimensional state space when being used for dealing with complex cloud environments. To resolve the problem, a deep reinforcement learning is provided to extract low dimensional representations from the high-dimensional state spaces by using deep neural networks. Although some DRL-based methods focus on the problem of cloud resource allocation, most of them use the value-based DRL, resulting in low training efficiency during processing of a relatively large action space. This is because the value-based DRL learns a deterministic policy by calculating a probability of each action. However, in the cloud data center, jobs may arrive constantly. Therefore, an action space may be considerably large to continuously meet the requirements of scheduling jobs. As a result, the value-based DRL is difficult to quickly converge to an optimal policy. By contrast, policy-based DRL (for example, a policy gradient (Policy Gradient, PG)) learns a stochastic policy and can better process a relatively large action space in the cloud data center by directly outputting actions with the probability distribution, but it may reduce the training efficiency caused by a high variance generated during estimation of the policy gradient.

As a synergy of the value-based DRL algorithm and the policy-based DRL algorithm, A2C (Advantage Actor Critical, A2C) aims to resolve the above problem. In the A2C model, the actor selects an action according to a score assessed by the critic, the variance of the policy gradient is reduced with an advantage function. However, the A2C adopts a single thread training mode, which makes insufficient use of computing resources. In addition, there is relatively strong data correlation during use of A2C, because when only one DRL agent interacts with an environment, similar training samples are generated, resulting in an unsatisfactory training result. To resolve these problems of the A2C algorithm, an asynchronous advantage actor-critic (A3C) algorithm with a low variance and high efficiency is provided. The A3C uses a plurality of DRL agents to simultaneously interact with the environment, making full use of computing resources and improving the learning rate. In addition, data collected by different DRL agents is independent of each other. Therefore, A3C breaks the correlation of data.

### SUMMARY

An objective of the present invention is to provide a deep reinforcement learning-based cloud data center adaptive efficient resource allocation method, and the method has higher quality of service in terms of a delay and a job dropout rate and has higher energy efficiency.

To achieve the objective, the technical solution of the present invention is as follows: a deep reinforcement learning-based cloud data center adaptive efficient resource allocation method is provided, a resource allocation model is designed, the resource allocation model takes a job delay, a dismissing rate, and energy efficiency as optimization goals; based on the resource allocation model, a state space, an action space, and a reward function of cloud resource allocation are defined as a Markov decision process, and the Markov decision process is used in a DRL (Deep Reinforcement Learning, DRL)-based cloud resource allocation method; an actor-critic DRL-based resource allocation method is provided, to resolve an optimal policy problem of job scheduling in cloud data center; and in addition, based on the actor-critic DRL-based resource allocation method, policy parameters among a plurality of DRL agents are asynchronously updated.

In an embodiment of the present invention, the DRL-based cloud resource allocation method specifically includes:
step S1: generating, by a resource allocation system RAS (Resource Allocation System, RAS), a job scheduling policy according to resource requests of jobs of different users and current state information of the cloud data center, where the resource allocation system RAS includes a DRL-based resource controller, a job scheduler, an information collector, and an energy agent;
step S2: allocating, by the job scheduler, a job in a job sequence to a server of the cloud data center according to a policy delivered by the DRL-based resource controller; and
step S3: recording, by the information collector during resource allocation, use conditions of different resources and current energy consumption measured by the energy agent in the cloud data center, and generating, by the DRL-based resource controller, the corresponding job scheduling policy.

In an embodiment of the present invention, a state space, an action space, and a reward function are defined as follows:
the state space: in a state space S, a state sₜ∈S is represented by a time step t and formed by resource usage of all servers and resource requests of all arrived jobs; on one hand, Uₜ^{res}=[[u_{1,1},u_{1,2}, . . . ,u_{1,n}], [u_{2,1},u_{2,2}, . . . ,u_{2,n}], . . . ,[u_{m,1},u_{m,2}, . . . ,u_{m,n}]], where u_{m,n} is a use condition of an n^{th} resource type on a server virtual machine; on the other hand, Oₜ^{res}=[[o_{1,1},o_{1,2}, . . . ,o_{1,n}], [o_{2,1},o_{2,2}, . . . ,o_{2,n}], . . . ,[o_{m,1},o_{m,2}, . . . ,o_{m,n}]], which represents occupancy requests of all arrived jobs for different resource types, where o_{j,n} is an occupancy request of a recently arrived job j for the n^{th} resource type, Dₜ^{job}=[d₁,d₂, . . . ,dⱼ] represents durations of all arrived jobs at the time step t, and dⱼ represents a duration of the job j, so that the state of the cloud data center at the time step t is defined as:

$${s}_{t} = [ {s}_{t}^{V} , {s}_{t}^{J} ] = [ {U}_{t}^{res} , [ {O}_{t}^{res} , {D}_{t}^{job} ] ] \qquad Formula ( 1 )$$

where sₜ^{V}=Uₜ^{res} and sₜ^{J}=[Oₜ^{res},Dₜ^{job}] are used for representing states of all the servers and arrived jobs, V={v₁, v₂, . . . , vₘ}, J represents a job sequence; and when a job arrives or is completed, the state space is changed, and a dimension of the state space depends on conditions of the server and the arrived job, which is calculated by (mn+z(n+1)), where m, n, and z respectively represent a quantity of servers, resource types, and arrived jobs;
the action space: at the time step t, an action performed by the job scheduler is to select and perform a job from the job sequence according to the job scheduling policy delivered by the DRL-based resource controller; the policy is generated according to a current state of the resource allocation system, and the job scheduler allocates a job to a corresponding server; once a job is scheduled to a corresponding server, the server automatically allocates a corresponding resource according to a resource request of the job; and therefore, an operation space A indicates only whether a job is processed by the server and is defined as:

$$A = \{ {a}_{t} \vert {a}_{t} ∈ \{ 0 , 1 , 2 , … , m \} \} \qquad Formula ( 2 )$$

where aₜ ∈A; and when aₜ=0, the job scheduler does not allocate the job at the time step t, and the job needs to wait in the job sequence; otherwise, the job is processed by the corresponding server;
a state transition probability matrix: the matrix represents probabilities of transition between two states, where there is no to-be-processed job at a time step t₀, and an initial state s₀=[0,[[0],[0]]], where three “0” items respectively represent the CPU usage (Central Processing Units, CPU) of a server, an occupancy request of a job, and a duration of the job; at t₁, a job j₁ is immediately scheduled because available resources are sufficient; after the operation is performed, the state develops into s₁=[50,[[50],[d₁]]];d₁, where the first “50” item represents utilization of the CPU of the server, the second “50” item represents an occupancy request of j₁ for a resource of the CPU, and d₁ represents a duration of j₁; and similarly, after j₂ is scheduled at t₂, the state develops into s₂=[80,[[50,30],[d₁,d₂]]], where the state transition probability matrix is denoted as IP(sₜ₊₁|sₜ,aₜ), which represents a probability of a transition to a next state sₜ₊₁ when one action aₜ is performed in a current state sₜ; and a value of the transition probability is obtained by running a DRL algorithm, and probabilities that different actions are adopted in a state are outputted by using the algorithm; and
the reward function: a DRL agent is guided to learn a better job scheduling policy with higher discounted long-term reward through the reward function, to improve system performance of cloud resource allocation; and therefore, at the time step t, a total reward Rₜ is formed by two parts of a QoS reward that is denoted as Rₜ^{QoS} and energy efficiency that is denoted as Rₜ^{energy} and is defined as:

$${R}_{t} = {R}_{t}^{QoS} + {R}_{t}^{energy} \qquad Formula ( 3 )$$

specifically, Rₜ^{QoS} reflects penalties of delays of different types at the time step t, which includes Tₜ^{j,wait}, Tₜ^{j,work}, and Tₜ^{j,miss} and is defined as:

$${R}_{t}^{Qos} = - {\sum }_{j ∈ {J}_{seq}} ( {w}_{1} \cdot \frac{{T}_{t}^{j , wait} + {T}_{t}^{j , work}}{{d}_{j}} + {w}_{2} \cdot {T}_{t}^{j , miss} ) \qquad Formula ( 4 )$$

where w₁ and w₂ are used for weighting the penalty; because Rₜ^{QoS} is a negative value, a job with a relatively long duration tends to wait for a relatively short time; and in addition, Rₜ^{energy} reflects a penalty for energy consumption at the time step t and is defined as:

$${R}_{t}^{energy} = - {w}_{3} \cdot {\sum }_{j ∈ {J}_{seq}} {E}_{t}^{j , exec} \qquad Formula ( 5 )$$

where Eₜ^{j,exec} is a time step t consumed to perform a job, and w₃ is a weight of the penalty.

In an embodiment of the present invention, the actor-critic DRL-based resource allocation method uses an actor-critic-based DRL framework and asynchronous advantage actor-critic A3C (Asynchronous Advantage Actor-Critic, A3C) to speed up a training process; specifically, the actor-critic DRL-based resource allocation method combines a value-based DRL algorithm and a policy-based DRL algorithm: on one hand, the value-based DRL determines a value function by using a function approximator, and balances exploration and development by using ∈-greedy; and on the other hand, the policy-based DRL parameterizes the job scheduling policy and outputs actions directly in probability distribution during learning without storing Q-values thereof.

In an embodiment of the present invention, in each DRL agent, a critic network Q^{π}^{_{θ}} estimates a state-action value function

$${Q}_{W} ( {s}_{t} , {a}_{t} ) \approx {Q}^{{π}_{{θ}_{t}}} ( {s}_{t} , {a}_{t} )$$

and updates a parameter w; in addition, an actor network V^{π}^{_{θ}} guides the update of a job scheduling policy parameter according to an estimation value of the critic network; and a corresponding policy gradient is defined as:

$${∇}_{{θ}_{t}} J ( {θ}_{t} ) = {E}_{{π}_{{θ}_{t}}} [ {∇}_{{θ}_{t}} {log}_{{π}_{{θ}_{t}}} ( {s}_{t} , {a}_{t} ) {Q}_{w} ( {s}_{t} , {a}_{t} ) ] \qquad Formula ( 6 )$$

$$J ( {θ}_{t} ) = {\sum }_{{s}_{t} ∈ S} {d}^{{π}_{{θ}_{t}}} ( {s}_{t} ) {\sum }_{{a}_{t} ∈ A} {π}_{{θ}_{t}} ( {s}_{t} , {a}_{t} ) {R}_{t} \qquad Formula ( 7 )$$

where

$${d}^{{π}_{{θ}_{t}}} ( {s}_{t} )$$

is stationary distribution of cloud resource allocation of MDP modeling where under placement of a current policy π_{θ}_{ₜ} scheduled for a job; and Rₜ is an instant reward; then, a variance during estimation of a gradient is reduced by using a state value function

$${V}^{{π}_{{θ}_{t}}} ( s ) ;$$

and the policy gradient is re-defined as:

$${∇}_{{θ}_{t}} J ( {θ}_{t} ) = {E}_{{π}_{{θ}_{t}}} [ {∇}_{{θ}_{t}} {log}_{{π}_{{θ}_{t}}} ( {s}_{t} , {a}_{t} ) {A}^{{π}_{{θ}_{t}}} ( {s}_{t} , {a}_{t} ) ] \qquad Formula ( 8 )$$

where

$${A}^{{π}_{{θ}_{t}}} ( {s}_{t} , {a}_{t} ) = {Q}^{{π}_{{θ}_{t}}} ( {s}_{t} , {a}_{t} ) - {V}^{{π}_{{θ}_{t}}} ( {s}_{t} )$$

is an advantage function; in addition,

$${V}^{{π}_{{θ}_{t}}} ( {s}_{t} )$$

is updated through TD learning, and a TD error is defined as:

$${δ}^{{π}_{{θ}_{t}}} = {R}_{t} + β {V}^{{π}_{{θ}_{t}}} ( {s}_{t + 1} ) - {V}^{{π}_{{θ}_{t}}} ( {s}_{t} ) ; and \qquad Formula ( 9 )$$

a plurality of DRL agents work simultaneously and asynchronously update parameters of job scheduling policies thereof; specifically, a predetermined quantity of DRL agents are initialized by using the same neural network local parameter, that is, a scheduling policy, and the DRL agents interact with corresponding cloud data center environments; for each DRL agent, gradients are accumulated periodically in the actor network and the critic network, and a parameter in a global network is updated asynchronously by using an RMSProp optimizer through gradient boosting; next, each DRL agent extracts latest parameters of the actor network and the critic network from the global network, and replaces local parameters with the latest parameters; each DRL agent continues to interact with the corresponding environment according to the updated local parameters, and independently optimizes the local parameters of the scheduling policy; there is no coordination between the DRL agents during local training; and according to the actor-critic DRL-based resource allocation method, training is continuously performed by using an asynchronous update mechanism between the plurality of DRL agents until a result converges.

Compared with the prior art, the beneficial effect of the present invention is as follows.

Through the A3C-based resource allocation method provided in the present invention, jobs are effectively scheduled, to improve QoS and energy efficiency of a cloud data center. A large amount of simulation experiments are performed by using real tracking data from the Google cloud data center to verify the effectiveness of the method in achieving adaptive and efficient resource allocation. Specifically, the method is superior to classical resource allocation methods such as LJF, Tetris, SJF, RR, PG, and DQL in terms of QoS (an average job delay and average job energy consumption) and energy efficiency (average job energy consumption). In addition, with the increase of an average load of a system, the training effect of the method is better than the other two methods, and the method has higher training efficiency (a faster convergence speed) than the two advanced DRL-based methods (PG and DQL). The simulation results show that the method is of great significance to improve the resource allocation of the cloud data center.

### BRIEF DESCRIPTION OF THE DRAWINGS

FIG. 1 is a resource allocation model of a cloud data center according to the present invention;

FIG. 2 is an example of cloud resource allocation of MDP process modeling according to the present invention;

FIG. 3 is a framework of an A3C-based cloud resource allocation method according to the present invention; and

FIG. 4 is a total return of different resource allocation methods under different system loads under a single objective optimization according to the present invention.

### DESCRIPTION OF THE EMBODIMENTS

The technical solution of the present invention is specifically described below with reference to the accompanying drawings.

The present invention provides a deep reinforcement learning-based cloud data center adaptive efficient resource allocation method. A unified resource allocation model is designed, the resource allocation model takes a job delay, a job dismissing rate, and energy efficiency as optimization goals; based on the resource allocation model, a state space, an action space, and a reward function of cloud resource allocation are defined as a Markov decision process, and the Markov decision process is used in a DRL-based cloud resource allocation method; an actor-critic DRL-based resource allocation method is provided, to resolve an optimal policy problem of job scheduling in cloud data center; and in addition, based on the actor-critic DRL-based resource allocation method, policy parameters of a plurality of DRL agents are asynchronously updated.

The following is a specific implementation process of the present invention.

In the present invention, a resource allocation problem of the cloud data center is described as a model-free DRL problem, and the problem has a dynamic system state and various user demands. Aiming at a cloud data center in a dynamic environment with heterogeneous resources, diversified user demands, high energy consumption, and aiming at the advantages of an A3C algorithm, the present invention provides an A3C-based resource allocation solution.

A unified resource allocation model is designed for the cloud data center with a dynamic system state and heterogeneous user demands. The model takes a job delay, a dismissing rate, and energy efficiency (average energy consumption of a job) as optimization goals. On this basis, a state space, an action space, and a reward function of cloud resource allocation are defined as a Markov decision process (MDP) and used in the DRL-based cloud resource allocation solution. An actor-critic DRL (A3C)-based resource allocation method is provided, to effectively resolve a problem of an optimal policy for job scheduling in the cloud data center. DNN is used for processing the problem of a high-dimensional state space of the cloud data center. In addition, the method greatly improves the training efficiency by asynchronously updating policy parameters among a plurality of DRL agents.

FIG. 1 shows a resource allocation model of a cloud data center. A DRL-based resource controller is embedded in a resource allocation system (RAS). The RAS generates job scheduling policies based on resource requests of jobs of different users and current state information (for example, a quantity of servers, a use condition of resources, and energy consumption) of the cloud data center. A job scheduler allocates a job to a server from a job sequence according to a policy delivered by the DRL-based resource controller. Specifically, these works will be extended to data processing works, for example, training works of a deep learning (DL) model for image processing and speech recognition. Different resource requests are displayed for different jobs according to purposes thereof. Therefore, each job is formed by a specific job duration (for example, minutes, hours, or days) and requests for resources of different types (for example, CPUs and memories). During resource allocation, an information collector records use conditions of different resources and current energy consumption (measured by an energy agent) in the cloud data center. Based on the above information, the DRL-based resource controller generates the corresponding job scheduling policies.

To achieve better quality of service and higher energy efficiency in the cloud data center, the present invention provides an asynchronous advantage actor-critic (A3C)-based cloud data center resource allocation method. The method uses an actor-critic-based DRL framework and asynchronous advantage actor-critic (A3C) to speed up a training process. Specifically, the A3C-based method combines a value-based DRL algorithm and a policy-based DRL algorithm. On one hand, the value-based DRL determines a value function by using a function approximator, and balances exploration and development by using ∈-greedy. Therefore, a DRL agent selects a good job scheduling operation based on existing experience, and simultaneously explores a new operation. On the other hand, the policy-based DRL parameterizes the job scheduling policy and directly outputs actions in probability distribution during learning without storing Q-values thereof.

### 1. Resource Allocation Model

To improve the quality of service quality and the energy efficiency, the present invention provides a DRL-based resource allocation method, including the following steps:

Step S1. An RAS generates job scheduling policies based on resource requests of jobs of different users and current state information (for example, a quantity of servers, resource usage, and energy consumption) of a cloud data center.

Step S2. A job scheduler allocates a job to a server from a job sequence according to a policy delivered by a DRL-based resource controller.

Step S3. During resource allocation, an information collector records use conditions of different resources and current energy consumption (measured by an energy agent) in the cloud data center. Based on the above information, the DRL-based resource controller generates the corresponding job scheduling policies.

A state space, an action space, and a reward function in DRL are defined as follows:

The state space: in a state space S, a state sₜ∈S is represented by a time step t and formed by resource usage of all servers and resource requests of all arrived jobs. On one hand, Uₜ^{res}=[[u_{1,1},u_{1,2}, . . . ,u_{1,n}], [u_{2,1},u_{2,2}, . . . ,u_{2,n}], . . . ,[u_{m,1},u_{m,2}, . . . ,u_{m,n}]], where U_{m,n} is a use condition of an n^{th} resource type on a server virtual machine. On the other hand, Oₜ^{res}=[[o_{1,1},o_{1,2}, . . . ,o_{1,n}], [o_{2,1},o_{2,2}, . . . ,o_{2,n}], . . . ,[o_{m,1},o_{m,2}, . . . ,o_{m,n}]], which represents occupancy requests of all arrived jobs for different resource types, (at the time step t), where o_{j,n} is an occupancy request of a recently arrived job j for the n^{th} resource type, and Dₜ^{job}=[d₁, d₂, . . . , dⱼ] represents durations of all arrived jobs at the time step t. Therefore, the state of the cloud data center by the time step t is defined as:

$${s}_{t} = [ {s}_{t}^{V} , {s}_{t}^{J} ] = [ {U}_{t}^{res} , [ {0}_{t}^{res} , {D}_{t}^{job} ] ] \qquad Formula ( 1 )$$

where sₜ^{V}=Uₜ^{res} and sₜ^{J}=[Oₜ^{res}, Dₜ^{job}] are used for representing states of all the servers and arrived jobs, to ensure a clear representation. When a job arrives or is completed, the state space is changed, and a dimension of the state space depends on conditions of the server and the arrived job, which is calculated by (mn+z(n+1)), where m, n, and z respectively represent a quantity of servers, resource types, and arrived jobs.

The action space: at the time step t, an action performed by the job scheduler is to select and perform a job from the job sequence according to a job scheduling policy delivered by the DRL-based resource controller. The policy is generated according to a current state of the system, and the job scheduler allocates a job to a corresponding server. Once a job is scheduled to a proper server, the server automatically allocates a corresponding resource according to a resource request of the job. Therefore, an operation space indicates only whether a job is processed by the server and is defined as:

$$A = \{ {a}_{t} \vert {a}_{t} ∈ \{ 0 , 1 , 2 , … , m \} \} \qquad Formula ( 2 )$$

where aₜ ∈A. When [symbol] , the job scheduler does not allocate the job at the time step t, and the job needs to wait in the job sequence. Otherwise, the job is processed by the specific server.

A state transition probability matrix: the matrix represents probabilities of the transition between two states. There is no to-be-processed job at a time step [symbol] , and an initial state s₀=[0, [[0],[0]]], where the three “0” items respectively represent the CPU usage of a server, an occupancy request of a job, and a duration of the job. At t₁, a job j₁ is immediately scheduled because available resources are sufficient. After the operation is performed, the state develops into s₁=[50,[[50],[d₁]]];d1, where the first “50” item represents utilization of the CPU of the server, the second “50” item represents an occupancy request of j₁ for a resource of the CPU, and d₁ represents a duration of j₁. Similarly, after J₂ is scheduled at t₁, the state develops into s₂=[80, [[50, 30], [d₁, d₂]]]. The state transition probability matrix is denoted as IP(sₜ₊₁|sₜ, aₜ), which represents a probability of a transition to a next state sₜ₊₁ when one action aₜ is performed in a current state sₜ. A value of the transition probability is obtained by running a DRL algorithm, and probabilities that different actions are adopted in a state are outputted by using the algorithm.

The reward function: a DRL agent (RAS) is guided to learn a better job scheduling policy with higher discounted long-term reward through the reward function, to improve system performance of cloud resource allocation. Therefore, at the time step t, a total reward Rₜ is formed by two parts of a QoS reward (which is denoted as Rₜ^{QoS}) and energy efficiency (which is denoted as hₜ^{energy}) and is defined as:

$${R}_{t} = {R}_{t}^{QoS} + {R}_{t}^{energy} \qquad Formula ( 3 )$$

Specifically, Rₜ^{QoS} reflects penalties (which are negative) of delays of different types at the time step t, which includes Tₜ^{j,wait}, Tₜ^{j,work}, and Tₜ^{j,miss} (as shown in Table 1) and is defined as:

$${R}_{t}^{QoS} = - {\sum }_{j ∈ {J}_{seq}} ( {w}_{t} \cdot \frac{{T}_{t}^{j , wait} + {T}_{t}^{j , work}}{{d}_{j}} + {w}_{2} \cdot {T}_{t}^{j , miss} ) \qquad Formula ( 4 )$$

where w₁ and w₂ are used for weighting the penalty. Because Rₜ^{QoS} is a negative value, a job with a relatively long duration tends to wait for a relatively short time. This is wise for the cloud system that aims to maximize profits because a longer job duration indicates a higher profit. In addition, Rₜ^{energy} reflects a penalty for energy consumption at the time step t and is defined as:

$${R}_{t}^{energy} = - {w}_{3} \cdot {\sum }_{j ∈ {J}_{seq}} {E}_{t}^{j , exec} \qquad Formula ( 5 )$$

where Eₜ^{j,exec} is a time step t consumed to perform a job, and w₃ is a weight of the penalty.

In this embodiment, the symbols are defined as follows:

Definition 1: Considering a scenario of one cloud data center, there is one group of servers, which are represented as V={v₁, v₂, . . . , Vₘ}, where m is a quantity of servers.

Definition 2: Each server provides a plurality of types of resources (for example, the CPU, a memory, and a storage unit), which are represented as Res={r₁, r₂, . . . , rₘ}, where n is a quantity of resource types.

Definition 3: Considering that there is a group of all jobs expected to be processed, which is represented as Jₜₒₜₐₗ={j₁, j₂, . . . , jₚ}, where p represents a total quantity of jobs.

Definition 4: A group of jobs are waiting in a job sequence, which is represented as J_{seq}={j₁, j₂, . . . , j_{q}}, where q represents a quantity of jobs waiting in the job sequence, and q≤p. When a job of Jₜₒₜₐₗ arrives, the job first enters J_{seq}. If the available resources are sufficient, the job can be processed immediately. Otherwise, the job waits for scheduling in the job sequence.

Definition 5: Because a numerical difference of a job delay value causes a long calculation time during gradient descent, a normalization algorithm is used to improve the training speed and the convergence of the algorithm. Therefore, Lₙₒᵣₘₐₗ is defined as a standardized average job delay, which is obtained by standardizing job delays of all successfully completed jobs and taking an average value of the standardized job delays, where Lₙₒᵣₘₐₗ≥1 and dⱼ is a duration of the job.

$${L}_{normal} = \frac{{\sum }_{j ∈ completed jobs} ( ( {T}_{finish}^{j} - {T}_{enter}^{j} ) / d )}{Number of completed jobs} \qquad Formula ( 6 )$$

Definition 6: disRate is defined as a job dismissing rate and is used for calculating a rate of dismissed jobs when the job sequence is full, where 0≤disRate≤1.

$$disRate = 1 - \frac{Number of completed jobs}{Total number of jobs} \qquad Formula ( 7 )$$

Definition 7: Total energy consumption of the cloud data center is Eₜₒₜₐₗ, where Pₘₐₓ is maximum energy consumption when the server is fully used, k is a server of which energy consumption is idle for calculating a ratio, Uₜ^{res} is resource usage of all the servers by the time step t, and t is the time step when the last job is completed.

$${E}_{total} = {\sum }_{t = 0}^{T} {\sum }_{v ∈ V} ( k \cdot {P}_{max} + ( 1 - k ) \cdot {P}_{max} \cdot {U}_{t}^{res} ) \qquad Formula ( 8 )$$

Definition 8: E_{job} is defined as energy efficiency during job scheduling (which is measured by average energy consumption of all the successfully completed jobs).

$${E}_{job} = \frac{{E}_{total}}{Number of completed jobs} \qquad Formula ( 9 )$$

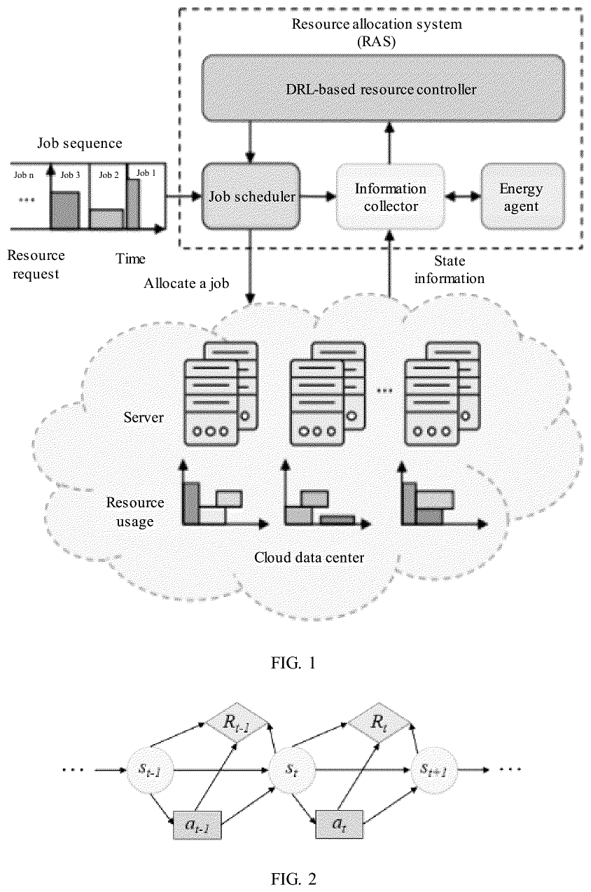

During optimization of cloud resource allocation, the DRL agent first selects an action aₜ (a scheduling job) in a current system state sₜ (resource usage and a resource request) of an environment (the cloud data center). Then, the DRL agent receives a reward Rₜ (QoS and energy efficiency) and enters a next state sₜ₊₁. The process is described by using the MDP, as shown in FIG. 2.

The present invention provides an asynchronous advantage actor-critic (A3C)-based cloud data center resource allocation method. Through the method, excellent QoS and energy efficiency can be implemented in the cloud data center. The method uses an actor-critic-based DRL framework and asynchronous advantage actor-critic (A3C) to speed up a training process. Specifically, the A3C-based method combines a value-based DRL algorithm and a policy-based DRL algorithm. On one hand, the value-based DRL determines a value function by using a function approximator, and balances exploration and development by using ∈-greedy. Therefore, a DRL agent selects a good job scheduling operation based on an existing experience, and simultaneously explores a new operation. On the other hand, the policy-based DRL parameterizes the job scheduling policy and directly outputs actions in probability distribution during learning without storing Q-values thereof.

Key steps of the A3C-based cloud resource allocation method provided in the present invention are shown in Algorithm 1.

Algorithm 1: A3C-based cloud data center resource allocation

```
  1. Initialize parameters and gradients of an actor network V^{πθ} and a critic network Q^{πθ}
  2. Initialize learning rates γₐ and γ_{c} of the actor network and the critic network, a reward decay rate
λ, and a discount factor β of a TD error, a counter temp=0, and update a quantity of steps u
  3. for each training epoch n=0, 1, 2 ,..., N do:
  4. Obtain an initial state s₀, where s₀ = env.observe( ):
  5. for t=0, 1, 2 ,..., T do:
  6. Select an action aₜ of a scheduling job according to a current system state sₜ of a cloud
computing data center, where sₜ = [sₜ^{V},sₜ^{J}] (which is defined in the formula 1), and aₜϵA (which is
defined in the formula 2): at = actor.choose_action(sₜ);
  7. Perform the action aₜ of the scheduling job, to obtain a reward Rₜ (quality of service and
energy efficiency) and a next state s_{t + 1}, where Rₜ = Rₜ^{Qos} + Rₜ^{enegy} (which is defined in the
formula 3): Rₜ, S_{t +} ₁ = env.step(aₜ);
  8. Calculate a long-term return after decay:
      ${R}_{disc} = {R}_{0} + λ {R}_{1} + … + {λ}^{t - 1} {R}_{t - 1} ;$
  9. Calculate an advantage function in the critic, where
      ${Q}_{w} ( {s}_{t} , {a}_{t} ) = {R}_{disc} + {λ}^{t} {V}^{{π}_{{θ}_{t}}} ( {s}_{t + 1} ) ; and {A}^{{π}_{{θ}_{t}}} ( {s}_{t} , {a}_{t} ) = {Q}_{w} ( {s}_{t} , {a}_{t} ) - {V}^{{π}_{{θ}_{t}}} ( {s}_{t} ) ;$
10. Minimize the TD error;
      ${δ}^{{π}_{{θ}_{t}}} = {R}_{t} + β {V}^{{π}_{{θ}_{t}}} ( {s}_{t + 1} ) - {V}^{{π}_{{θ}_{t}}} ( {s}_{t} ) ;$
11. Update a parameter of a state-action value function:
  ${w}_{t + 1} ← {w}_{t} + {γ}_{c} {δ}^{{ω}_{{θ}_{t}}} {∇}_{w} ( {s}_{t} , {a}_{t} ) ;$
12. Calculate a policy gradient in actor by using the advantage function:
  ${∇}_{{θ}_{t}} J ( {θ}_{t} ) = {E}_{{π}_{{θ}_{t}}} [ {∇}_{{θ}_{t}} log {π}_{{θ}_{t}} ( {s}_{t} , {a}_{t} ) {A}^{{π}_{{θ}_{i}}} ( {s}_{t} , {a}_{t} ) ] ;$
13. Update a scheduling policy: θ_{t + 1}←θₜ + γₐ∇_{θ}_{ₜ}J(θₜ);
14. Update the state: sₜ = s_{t + 1};
15. Update the counter: temp = temp + 1;
16. if temp % u = = 0 then:
17. Call a parameter of an asynchronous advantage policy in each DRL agent in Algorithm 2;
18. end
19. end
20. end
```

Based on the definitions of the state space in the formula (1), the action space in the formula (2), and the reward function in the formula (3), weighting and bias initialization are first performed on the actor network V^{π}^{_{θ}} and the critic network Q^{π}^{_{θ}}. Then, the learning rates γₐ and γₑ of actor and critic are initialized, and the discount factor β of the TD error is initialized.

The optimization goal of the provided A3C-based resource allocation method is to obtain a maximum benefit. Therefore, the instant reward Rₜ (which is defined in the formula (7)) is accumulated through probability distribution:

$$J ( {θ}_{t} ) = {\sum }_{{s}_{t} ∈ S} {d}^{{π}_{{θ}_{t}}} ( {s}_{t} ) {\sum }_{{a}_{t} ∈ A} {π}_{{θ}_{t}} ( {s}_{t} , {a}_{t} ) {R}_{t} \qquad Formula ( 10 )$$

where

$${d}^{{π}_{{θ}_{t}}} ( {s}_{t} )$$

is stationary distribution of cloud resource allocation of MDPs modeling under placement of a current policy π_{θ}_{ₜ} scheduled for a job.

After initialization, a training process of cloud resource allocation starts to be optimized. To improve the optimization goal, the parameter of the job scheduling policy is continuously updated.

In one-step policy planning, a policy gradient of an objective function is defined as:

$${∇}_{θ} J ( {θ}_{t} ) = {E}_{{π}_{{θ}_{t}}} [ {∇}_{{θ}_{t}} {log}_{{π}_{{θ}_{t}}} ( {s}_{t} , {a}_{t} ) {R}_{t} ] \qquad Formula ( 11 )$$

For multi-step MDPs, the instant reward Rₜ is replaced with a long-term value

$${Q}^{{π}_{{θ}_{t}}} ( {s}_{t} , {a}_{t} ) ,$$

and a decision gradient theorem is defined as:

Theorem 1. Policy gradient theorem [13]: for any micro policy π_{θ}_{ₜ}(sₜ,aₜ) and any policy objective function, a corresponding gradient is defined as:

$${∇}_{{θ}_{t}} J ( {θ}_{t} ) = {E}_{{π}_{{θ}_{t}}} [ {∇}_{{θ}_{t}} {log}_{{π}_{{θ}_{t}}} ( {s}_{t} , {a}_{t} ) {Q}^{{π}_{{θ}_{t}}} ( {s}_{t} , {a}_{t} ) ] \qquad Formula ( 12 )$$

On this basis, through time domain differential learning, a state value is accurately estimated and the update of the policy parameter is guided.

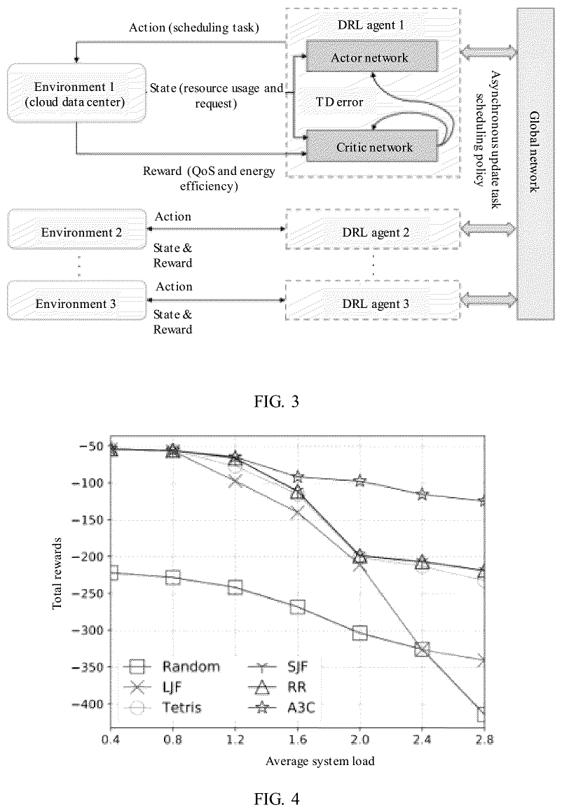

FIG. 3 is a framework of an A3C-based cloud resource allocation method provided in this specification. In this method, a relatively large action space can be processed based on the policy-based DRL and the value-based DRL, and the variance is reduced during gradient estimation.

In each DRL agent, the critic network estimates the state-action value function

$${Q}_{W} ( {s}_{t} , {a}_{t} ) \approx {Q}^{{π}_{{θ}_{t}}} ( {s}_{t} , {a}_{t} )$$

and updates the parameter w. In addition, the actor network guides the update of the parameter of the job scheduling policy according to an estimation value of the critic network. A corresponding policy gradient is defined as:

$${∇}_{{θ}_{t}} J ( {θ}_{t} ) = {E}_{{π}_{{θ}_{t}}} [ {∇}_{{θ}_{t}} {log}_{{π}_{{θ}_{t}}} ( {s}_{t} , {a}_{t} ) {Q}_{w} ( {s}_{t} , {a}_{t} ) ] \qquad Formula ( 13 )$$

Next, the variance during gradient estimation is reduced by using the state value function

$${V}^{{π}_{{θ}_{t}}} ( s ) ,$$

and the variance is related to only the state, and the gradient is not changed. Therefore, the policy gradient is re-defined as:

$${∇}_{{θ}_{t}} J ( {θ}_{t} ) = {E}_{{π}_{{θ}_{t}}} [ {∇}_{{θ}_{t}} {log}_{{π}_{{θ}_{t}}} ( {s}_{t} , {a}_{t} ) {A}^{{π}_{{θ}_{t}}} ( {s}_{t} , {a}_{t} ) ] \qquad Formula ( 14 )$$

where

$${A}^{{π}_{{θ}_{t}}} ( {s}_{t} , {a}_{t} ) = {Q}^{{π}_{{θ}_{t}}} ( {s}_{t} , {a}_{t} ) - {V}^{{π}_{{θ}_{t}}} ( {s}_{t} )$$

is an advantage function. In addition,

$${V}^{{π}_{{θ}_{t}}} ( {s}_{t} )$$

is updated through TD learning, and a TD error is defined as:

$${δ}^{{π}_{{θ}_{t}}} = {R}_{t} + β {V}^{{π}_{{θ}_{t}}} ( {s}_{t + 1} ) - {V}^{{π}_{{θ}_{t}}} ( {s}_{t} ) \qquad Formula ( 15 )$$

To improve the training efficiency, a plurality of DRL agents work simultaneously and asynchronously update parameters of job scheduling policies thereof, as shown in Algorithm 2. Specifically, a predetermined quantity of DRL agents are initialized by using the same neural network local parameter (that is, a scheduling policy) and the DRL agents interact with corresponding cloud data center environments. For each DRL agent, gradients are accumulated periodically in the actor network and the critic network, and a parameter in a global network is updated asynchronously by using an RMSProp optimizer through gradient boosting. Next, each DRL agent extracts latest parameters of the actor network and the critic network from the global network, and replaces local parameters with the latest parameters. Each DRL agent continues to interact with the corresponding environment according to the updated local parameters, and independently optimizes the local parameters of the scheduling policy. It should be noted that there is no coordination between the DRL agents during local training. Based on the A3C-based method, training is continuously performed by using an asynchronous update mechanism between the plurality of DRL agents until a result converges.

Algorithm 2: asynchronous update of parameters of job scheduling policies in DRL agent

```
  1. Initialize a global parameter and a local parameter (θ and θ′) of an actor network and a global parameter
and a local parameter (w and w′) of a critic network
  2. for i = temp − u,temp − u + 1,...,temp do:
  3. Calculate a gradient dθ←dθ + ∇_{θ′}logπ_{θ′}(sᵢ,aᵢ) (Rᵢ − V_{w}(sᵢ)) of the actor network;
  4. Calculate a gradient dw←dw + ∂(Rᵢ − V_{w}(sᵢ))²/∂w′ of the critic network;
  5. end
  6. Update the global parameters by using RMSProp through gradient boosting:
  $θ = θ + {γ}_{a} d θ , w = w + {γ}_{c} dw ;$
  7. Synchronize the local parameters: θ′ = θ, w′ = w; and
  8. Reset the gradients: dθ←0, dw←0;
```

### 2. Method Evaluation

The cloud resource allocation model provided in the present invention is implemented based on TensorFlow 1.4.0. For example, a cloud data center is simulated by using 50 heterogeneous servers, energy consumption k of an idle server is set to 70%, and maximum energy consumption Pₘₐₓ of a server is set to 250 W. Therefore, as a resource utilization ratio increases from 0% to 100%, the energy consumption of the server is distributed between 175 W and 250 W. In addition, real world tracking data from the Google cloud data center is used as input of the model. A dataset includes resource usage data of different jobs of more than 125,000 servers in the Google cloud data center in May 2011. More specifically, 50 servers are randomly extracted from the Google dataset over 29 days, and each server is formed by about 100,000 job tracks. Next, several basic indicators are extracted from each job tracking, including: a machine ID, a job ID, a start time, an end time, and corresponding resource usage. In addition, a length of a job sequence is set to 1000.

During training, 10 DRL agents are used to update policy parameters asynchronously. In each DRL agent, the job tracking data is provided to the proposed model in batches, where the batch size is set to 64. In the design of DNN, 200 neurons and 100 neurons are respectively used to construct two completely connected hidden layers. In addition, a maximum quantity of epochs is set to 1000, a reward decay rate λ is set to 0.9, and a learning rate γₑ of critic is set to 0.01.

Based on the above settings, a large amount of simulation experiments are performed to evaluate the performance of the provided A3C-based cloud resource allocation method.

To analyze the effectiveness and advantages of the provided cloud resource allocation method, a large amount of comparative experiments are performed, and five classical algorithms are evaluated as follows.

A random scheduling algorithm (Random): jobs are performed in a random order of job durations.

A longest job first scheduling algorithm (Longest job first, LJF): the jobs are performed in descending order of job durations.

A shortest job first scheduling algorithm (Shortest job first, SJF): the jobs are performed in ascending order of job durations.

A round-robin scheduling algorithm (Round-robin, RR): the jobs are performed fairly in a circular order, and time slices are used and allocated to each job in an equal proportion.

A Tetris scheduling algorithm: the jobs are performed according to resource demands of the jobs and the availability of system resources upon arrival.

As shown in FIG. 4, a total reward (representing QoS) generally decreases with the increase of an average system load. In this case, even if the average system load becomes larger, the provided method can always obtain a higher total return than other methods. In contrast, other classical methods have comparable performance only when the average system load is less than 1.2. In particular, when the average system load is greater than 2.0, the performance of the classical methods is only slightly better than that of the random solution. When the average system load exceeds 2.4, the performance of the LJF method is even worse than that of the random solution. This is because the average system load is high when a large quantity of jobs are waiting to be processed, but according to the LJF method, jobs with the longest working time are always first arranged, and a plurality of jobs wait excessively, which seriously reduces the scheduling performance. In contrast, the method always maintains good performance. The experimental results verify the superiority of the method provided in the present invention in scheduling jobs in a complex environment with a high system load.

### 3. Use Process of a Product in the Present Invention

(1) An RAS generates job scheduling policies based on resource requests of jobs of different users and current state information (for example, a quantity of servers, resource usage, and energy consumption) of the cloud data center.

(2) A job scheduler allocates a job to a server from a job sequence according to a policy delivered by the DRL-based resource controller.

(3) During resource allocation, an information collector records use conditions of different resources and current energy consumption (measured by an energy agent) in the cloud data center. Based on the above information, the DRL-based resource controller generates the corresponding job scheduling policies.

The above is the preferred embodiments of the present invention. A functional effect produced by any change made according to the technical solution of the present invention does not exceed the scope of the technical solution of the present invention and falls within the protection scope of the present invention.

1. A deep reinforcement learning (DRL)-based cloud data center adaptive efficient resource allocation method, wherein a unified resource allocation model is designed, the resource allocation model takes a job delay, a job dismissing rate, and energy efficiency as optimization goals; based on the resource allocation model, a state space, an action space, and a reward function of cloud resource allocation are defined as a Markov decision process, and the Markov decision process is used in a DRL-based cloud resource allocation method; an actor-critic DRL-based resource allocation method is provided, to resolve an optimal policy problem of job scheduling in cloud data center; and in addition, based on the actor-critic DRL-based resource allocation method, policy parameters of a plurality of DRL agents are asynchronously updated.

2. The deep reinforcement learning-based cloud data center adaptive efficient resource allocation method according to claim 1, wherein the DRL-based cloud resource allocation method specifically comprises:
step S1: generating, by a resource allocation system RAS, a job scheduling policy according to resource requests of jobs of different users and current state information of the cloud data center, wherein the resource allocation system RAS comprises a DRL-based resource controller, a job scheduler, an information collector, and an energy agent;
step S2: allocating, by the job scheduler, a job in a job sequence to a server of the cloud data center according to a policy delivered by the DRL-based resource controller; and
step S3: recording, by the information collector during resource allocation, use conditions of different resources and current energy consumption measured by the energy agent in the cloud data center, and generating, by the DRL-based resource controller, the corresponding job scheduling policy.

3. The deep reinforcement learning-based cloud data center adaptive efficient resource allocation method according to claim 2, wherein a state space, an action space, and a reward function in the DRL are defined as follows:
the state space: in a state space S, a state sₜ∈S is represented by a time step t and formed by resource usage of all servers and resource requests of all arrived jobs; on one hand, Uₜ^{res}=[[u_{1,1},u_{1,2}, . . . ,u_{1,n}], [u_{2,1},u_{2,2}, . . . ,u_{2,n}], . . . ,[u_{m,1},u_{m,2}, . . . ,u_{m,n}]], where u_{m,n} is a use condition of an n^{th} resource type on a server virtual machine; on the other hand, Oₜ^{res}=[[o_{1,1},o_{1,2}, . . . ,o_{1,n}], [o_{2,1},o_{2,2}, . . . ,o_{2,n}], . . . ,[o_{m,1},o_{m,2}, . . . ,o_{m,n}]], which represents occupancy requests of all arrived jobs for different resource types, where o_{j,n} is an occupancy request of a recently arrived job j for the n^{th} resource type, Dₜ^{job}=[d₁,d₂, . . . ,dⱼ] represents durations of all arrived jobs at the time step t, and dⱼ represents a duration of the job j, so that the state of the cloud data center at the time step t is defined as:
$${s}_{t} = [ {s}_{t}^{V} , {s}_{t}^{J} ] = [ {U}_{t}^{res} , [ {O}_{t}^{res} , {D}_{t}^{job} ] ] \qquad Formula ( 1 )$$
where sₜ^{V}=Uₜ^{res} and sₜ^{J}=[Oₜ^{res},Dₜ^{job}] are used for representing states of all the servers and arrived jobs, V={v₁, v₂, . . . , vₘ}, J represents a job sequence; and when a job arrives or is completed, the state space is changed, and a dimension of the state space depends on conditions of the server and the arrived job, which is calculated by (mn+z(n+1)), where m, n, and z respectively represent a quantity of servers, resource types, and arrived jobs;
the action space: at the time step t, an action performed by the job scheduler is to select and perform a job from the job sequence according to the job scheduling policy delivered by the DRL-based resource controller; the policy is generated according to a current state of the resource allocation system, and the job scheduler allocates a job to a corresponding server; once a job is scheduled to a corresponding server, the server automatically allocates a corresponding resource according to a resource request of the job; and therefore, an operation space A indicates only whether a job is processed by the server and is defined as:
$$A = \{ {a}_{t} \vert {a}_{t} ∈ \{ 0 , 1 , 2 , … , m \} \} \qquad Formula ( 2 )$$
where aₜ ∈A; and when aₜ=0, the job scheduler does not allocate the job at the time step t, and the job needs to wait in the job sequence; otherwise, the job is processed by the corresponding server;
a state transition probability matrix: the matrix represents probabilities of transition between two states, where there is no to-be-processed job at a time step t₀, and an initial state s₀=[0,[[0],[0]]], where three “0” items respectively represent the CPU usage of a server, an occupancy request of a job, and a duration of the job; at t₁, a job j₁ is immediately scheduled because available resources are sufficient; after the operation is performed, the state develops into s₁=[50,[[50],[d₁]]],d₁, where the first “50” item represents utilization of the CPU of the server, the second “50” item represents an occupancy request of j₁ for CPU resource, and d₁ represents a duration of j₁; and similarly, after j₂ is scheduled at t₂, the state develops into s₂=[80,[[50,30],[d₁,d₂]]], where the state transition probability matrix is denoted as IP(sₜ₊₁|sₜ,aₜ), which represents a probability of a transition to a next state sₜ₊₁ when one action aₜ is performed in a current state sₜ; and a value of the transition probability is obtained by running a DRL algorithm, and probabilities that different actions are adopted in a state are outputted by using the algorithm; and
the reward function: a DRL agent is guided to learn a better job scheduling policy with higher discounted long-term reward through the reward function, to improve system performance of cloud resource allocation; and therefore, at the time step t, a total reward Rₜ is formed by two parts of a QoS reward that is denoted as Rₜ^{QoS} and energy efficiency that is denoted as Rₜ^{energy} and is defined as:
$${R}_{t} = {R}_{t}^{QoS} + {R}_{t}^{energy} \qquad Formula ( 3 )$$
specifically, Rₜ^{QoS} reflects penalties of delays of different types at the time step t, which includes Tₜ^{j,wait}, Tₜ^{j,work}, and Tₜ^{j,miss} and is defined as:
$${R}_{t}^{Qes} = - {\sum }_{j ∈ {J}_{seq}} ( {w}_{1} \cdot \frac{{T}_{t}^{j , wait} + {T}_{t}^{j , work}}{{d}_{j}} + {w}_{2} \cdot {T}_{t}^{j , miss} ) \qquad Formula ( 4 )$$
where w₁ and w₂ are used for weighting the penalty; because Rₜ^{QoS} is a negative value, a job with a relatively long duration tends to wait for a relatively short time; and in addition, Rₜ^{energy} reflects a penalty for energy consumption at the time step t and is defined as:
$${R}_{t}^{energy} = - {w}_{3} \cdot {\sum }_{j ∈ {J}_{seg}} {E}_{t}^{j , exec} \qquad Formula ( 5 )$$
where
$${E}^{\begin{matrix}j , exec \\ t\end{matrix}}$$
is a time step t consumed to perform a job, and w₃ is a weight of the penalty.

4. The deep reinforcement learning-based cloud data center adaptive efficient resource allocation method according to claim 1, wherein the actor-critic DRL-based resource allocation method uses an actor-critic-based DRL framework and asynchronous advantage actor-critic A3C to speed up a training process; specifically, the actor-critic DRL-based resource allocation method combines a value-based DRL algorithm and a policy-based DRL algorithm: on one hand, the value-based DRL determines a value function by using a function approximator, and balances exploration and development by using ∈-greedy; and on the other hand, the policy-based DRL parameterizes the job scheduling policy and outputs actions directly in probability distribution during learning without storing Q-values thereof.

5. The deep reinforcement learning-based cloud data center adaptive efficient resource allocation method according to claim 3, wherein in each DRL agent, a critic network Q^{π}^{_{θ}} estimates a state-action value function
$${Q}_{W} ( {s}_{t} , {a}_{t} ) \approx {Q}^{{π}_{{θ}_{t}}} ( {s}_{t} , {a}_{t} )$$
and updates a parameter w; in addition, an actor network V^{π}^{_{θ}} guides the update of a job scheduling policy parameter according to an estimation value of the critic network; and a corresponding policy gradient is defined as:
$${∇}_{{θ}_{t}} J ( {θ}_{t} ) = {E}_{{π}_{{θ}_{t}}} [ {∇}_{{θ}_{t}} {log}_{{π}_{{θ}_{t}}} ( {s}_{t} , {a}_{t} ) {Q}_{w} ( {s}_{t} , {a}_{t} ) ] \qquad Formula ( 6 )$$
$$J ( {θ}_{t} ) = {\sum }_{{s}_{t} ∈ S} {d}^{{π}_{{θ}_{t}}} ( {s}_{t} ) {\sum }_{{a}_{i} ∈ A} {π}_{{θ}_{t}} ( {s}_{t} , {a}_{t} ) {R}_{t} \qquad Formula ( 7 )$$
wherein
$${d}^{{π}_{{θ}_{t}}} ( {s}_{t} )$$
is stationary distribution of cloud resource allocation of MDP (Markov Decision Process) modeling under placement of a current policy π_{θ}_{ₜ} scheduled for a job; and Rₜ is an instant reward;
then, a variance during estimation of a gradient is reduced by using a state value function
$${V}^{{π}_{{θ}_{t}}} ( s ) ;$$
and the policy gradient is re-defined as:
$${∇}_{{θ}_{t}} J ( {θ}_{t} ) = {E}_{{π}_{{θ}_{t}}} [ {∇}_{{θ}_{t}} {log}_{{π}_{{θ}_{t}}} ( {s}_{t} , {a}_{t} ) {A}^{{π}_{{θ}_{t}}} ( {s}_{t} , {a}_{t} ) ] \qquad Formula ( 8 )$$
wherein
$${A}^{{π}_{{θ}_{t}}} ( {s}_{t} , {a}_{t} ) = {Q}^{{π}_{{θ}_{t}}} ( {s}_{t} , {a}_{t} ) - {V}^{{π}_{{θ}_{t}}} ( {s}_{t} )$$
is an advantage function; in addition,
$${V}^{{π}_{{θ}_{t}}} ( {s}_{t} )$$
is updated through TD learning, and a TD error is defined as:
$${δ}^{{π}_{{θ}_{t}}} = {R}_{t} + β {V}^{{π}_{{θ}_{t}}} ( {s}_{t + 1} ) - {V}^{{π}_{{θ}_{t}}} ( {s}_{t} ) ; and \qquad Formula ( 9 )$$
a plurality of DRL agents work simultaneously and asynchronously update parameters of job scheduling policies thereof; specifically, a predetermined quantity of DRL agents are initialized by using the same neural network local parameter, that is, a scheduling policy, and the DRL agents interact with corresponding cloud data center environments; for each DRL agent, gradients are accumulated periodically in the actor network and the critic network, and a parameter in a global network is updated asynchronously by using an RMSProp optimizer through gradient boosting; next, each DRL agent extracts latest parameters of the actor network and the critic network from the global network, and replaces local parameters with the latest parameters; each DRL agent continues to interact with the corresponding environment according to the updated local parameters, and independently optimizes the local parameters of the scheduling policy; there is no coordination between the DRL agents during local training; and according to the actor-critic DRL-based resource allocation method, training is continuously performed by using an asynchronous update mechanism between the plurality of DRL agents until a result converges.
